(19) United States
(12) Patent Application Publication
(10) Pub. No.: US 2021/0314556 A1
(43) Pub. Date: Oct. 7, 2021

(54) MULTIVIEW DISPLAY SYSTEM, MULTIVIEW DISPLAY, AND METHOD HAVING A VIEW-TERMINUS INDICATOR

(71) Applicant: LEIA INC., Menlo Park, CA (US)

(72) Inventors: David A. Fattal, Menlo Park, CA (US); Daniel Geisler, JR., Menlo Park, CA (US)

(21) Appl. No.: 17/351,059

(22) Filed: Jun. 17, 2021

Related U.S. Application Data
(63) Continuation of application No. PCT/US2018/067177, filed on Dec. 21, 2018.

(51) Int. Cl. H04N 13/366; H04N 13/183; G06F 3/01; H04N 13/32; H04N 13/356

(52) U.S. Cl. CPC H04N 13/366; H04N 13/183; H04N 13/356; H04N 13/32; G06F 3/016

(57) ABSTRACT

A multiview display system employs a multiview display configured to provide a plurality of views representing a multiview image and a view-terminus indicator associated with a terminal view of the view plurality. The view-terminus indicator is configured to alert a user of the multiview display system to an angular terminus of the view plurality.

### CROSS-REFERENCE TO RELATED APPLICATIONS

This application is a continuation application of and claims the benefit of priority to International Patent Application No. PCT/US2018/067177, filed Dec. 21, 2018, the entirety of which is incorporated by reference herein.

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Most commonly employed electronic displays include the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). Generally, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light.

To overcome the limitations of passive displays associated with emitted light, many passive displays are coupled to an external light source. The coupled light source may allow these otherwise passive displays to emit light and function substantially as active displays. Examples of such coupled light sources are backlights. A backlight may serve as a source of light (often a panel backlight) that is placed behind an otherwise passive display to illuminate the passive display. For example, a backlight may be coupled to an LCD or an EP display. The backlight emits light that passes through the LCD or the EP display. The light emitted is modulated by the LCD or the EP display and the modulated light is then emitted, in turn, from the LCD or the EP display. Often backlights are configured to emit white light. Color filters are then used to transform the white light into various colors used in the display. The color filters may be placed at an output of the LCD or the EP display (less common) or between the backlight and the LCD or the EP display, for example. Alternatively, the various colors may be implemented by field-sequential illumination of a display using different colors, such as primary colors.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1A illustrates a perspective view of a multiview display in an example, according to an embodiment consistent with the principles described herein.

FIG. 1B illustrates a graphical representation of the angular components of a light beam having a particular principal angular direction corresponding to a view direction of a multiview display in an example, according to an embodiment consistent with the principles described herein.

FIG. 2A illustrates a block diagram of a multiview display system in an example, according to an embodiment consistent with the principles described herein.

FIG. 2B illustrates a perspective view of a multiview display system in an example, according to an embodiment consistent with the principles described herein.

FIG. 3A illustrates a planar projection of a plurality of views of the multiview display system of FIG. 2A in an example, according to an embodiment consistent with the principles described herein.

FIG. 3B illustrates a planar projection of a plurality of views of the multiview display system of FIG. 2A in an example, according to another embodiment consistent with the principles described herein.

FIGS. 4A-4D illustrate various graphical overlays in examples, according to embodiments consistent with the principles described herein.

FIG. 5A illustrates another plurality of views comprising terminal views in an example, according to an embodiment consistent with the principles described herein.

FIG. 5B illustrates a side view of an angular extent of the plurality of views of FIG. 5A in an example, according to an embodiment consistent with the principles described herein.

FIG. 6A illustrates a cross-sectional view of a multiview display in an example, according to an embodiment consistent with the principles described herein.

FIG. 6B illustrates a cross-sectional view of a multiview display system comprising a broad-angle backlight in an example, according to an embodiment consistent with the principles described herein.

FIG. 7 illustrates a block diagram of a multiview display in an example, according to an embodiment consistent with the principles described herein.

FIG. 8 illustrates a flowchart of a method of multiview display operation in an example, according to an embodiment consistent with the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Examples and embodiments in accordance with the principles described herein provide a multiview display system employing a view-terminus indicator with application to electronic displays. In various embodiments consistent with the principles herein, a multiview display system is provided. The multiview display system is configured to provide a plurality of views representing a multiview image. The multiview display system further comprises a view-terminus indicator configured to alert a user of the multiview display system to an angular terminus of the view plurality.

Herein a ‘two-dimensional display’ or ‘2D display’ is defined as a display configured to provide a view of an image that is substantially the same regardless of a direction from which the image is viewed (i.e., within a predefined viewing angle or range of the 2D display). A liquid crystal display (LCD) found in may smart phones and computer monitors are examples of 2D displays. In contrast herein, a ‘multiview display’ is defined as an electronic display or display system configured to provide different views of a multiview image in or from different view directions. In particular, the different views may represent different perspective views of a scene or object of the multiview image. In some instances, a multiview display may also be referred to as a three-dimensional (3D) display, e.g., when simultaneously viewing two different views of the multiview image provides a perception of viewing a three dimensional image.

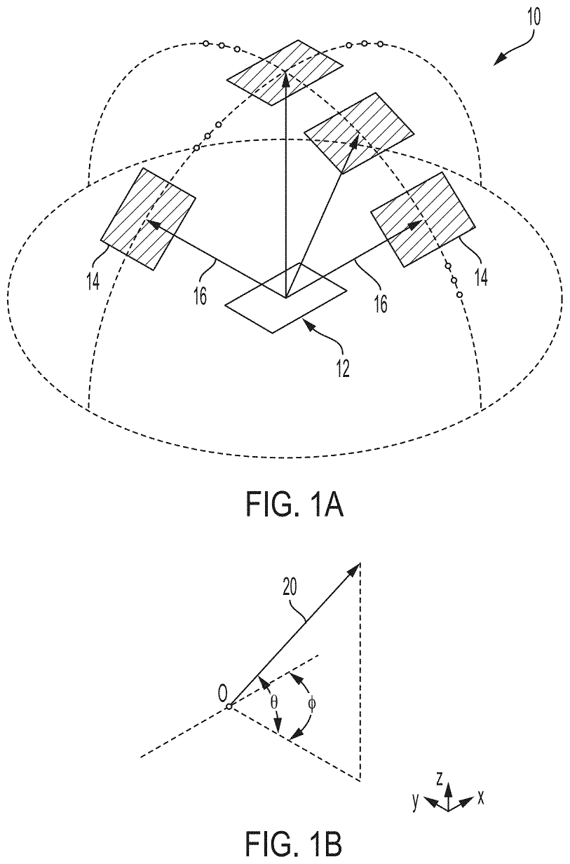

FIG. 1A illustrates a perspective view of a multiview display 10 in an example, according to an embodiment consistent with the principles described herein. As illustrated in FIG. 1A, the multiview display 10 comprises a screen 12 to display a multiview image to be viewed. The multiview display 10 provides different views 14 of the multiview image in different view directions 16 relative to the screen 12. The view directions 16 are illustrated as arrows extending from the screen 12 in various different principal angular directions; the different views 14 are illustrated as shaded polygonal boxes at the termination of the arrows (i.e., depicting the view directions 16); and only four views 14 and four view directions 16 are illustrated, all by way of example and not limitation. Note that while the different views 14 are illustrated in FIG. 1A as being above the screen, the views 14 actually appear on or in a vicinity of the screen 12 when the multiview image is displayed on the multiview display 10. Depicting the views 14 above the screen 12 is only for simplicity of illustration and is meant to represent viewing the multiview display 10 from a respective one of the view directions 16 corresponding to a particular view 14.

A view direction or equivalently a light beam having a direction corresponding to a view direction of a multiview display generally has a principal angular direction given by angular components {θ, φ}, by definition herein. The angular component θ is referred to herein as the ‘elevation component’ or ‘elevation angle’ of the light beam. The angular component φ is referred to as the ‘azimuth component’ or ‘azimuth angle’ of the light beam. By definition, the elevation angle θ is an angle in a vertical plane (e.g., perpendicular to a plane of the multiview display screen while the azimuth angle φ is an angle in a horizontal plane (e.g., parallel to the multiview display screen plane).

FIG. 1B illustrates a graphical representation of the angular components {θ, φ} of a light beam 20 having a particular principal angular direction corresponding to a view direction (e.g., view direction 16 in FIG. 1A) of a multiview display in an example, according to an embodiment consistent with the principles described herein. In addition, the light beam 20 is emitted or emanates from a particular point, by definition herein. That is, by definition, the light beam 20 has a central ray associated with a particular point of origin within the multiview display. FIG. 1B also illustrates the light beam (or view direction) point of origin O.

Further herein, the term ‘multiview’ as used in the terms ‘multiview image’ and ‘multiview display’ is defined as a plurality of views representing different perspectives or including angular disparity between views of the view plurality. In addition, herein the term ‘multiview’ explicitly includes more than two different views (i.e., a minimum of three views and generally more than three views), by definition herein. As such, ‘multiview display’ as employed herein is explicitly distinguished from a stereoscopic display that includes only two different views to represent a scene or an image. Note however, while multiview images and multiview displays include more than two views, by definition herein, multiview images may be viewed (e.g., on a multiview display) as a stereoscopic pair of images by selecting only two of the multiview views to view at a time (e.g., one view per eye).

By definition herein, a ‘multibeam emitter’ is a structure or element of a backlight or a display that produces light that includes a plurality of light beams. In some embodiments, the multibeam emitter may be optically coupled to a light guide of a backlight to provide the light beams by coupling out a portion of light guided in the light guide. In such embodiments, a multibeam emitter may comprise a ‘multibeam element.’ In other embodiments, the multibeam emitter may generate light emitted as the light beams (i.e., may comprise a light source). Further, the light beams of the plurality of light beams produced by a multibeam emitter have different principal angular directions from one another, by definition herein. In particular, by definition, a light beam of the plurality has a predetermined principal angular direction that is different from another light beam of the light beam plurality. Furthermore, the light beam plurality may represent a light field. For example, the light beam plurality may be confined to a substantially conical region of space or have a predetermined angular spread that includes the different principal angular directions of the light beams in the light beam plurality. As such, the predetermined angular spread of the light beams in combination (i.e., the light beam plurality) may represent the light field. According to various embodiments, the different principal angular directions of the various light beams are determined by a characteristic including, but not limited to, a size (e.g., length, width, area, etc.) of the multibeam emitter. In some embodiments, the multibeam emitter may be considered an ‘extended point light source’, i.e., a plurality of point light sources distributed across an extent of the multibeam emitter, by definition herein. Further, a light beam produced by the multibeam emitter has a principal angular direction given by angular components {θ, ϕ}, by definition herein, and as described above with respect to FIG. 1B.

Herein, a ‘light guide’ is defined as a structure that guides light within the structure using total internal reflection. In particular, the light guide may include a core that is substantially transparent at an operational wavelength of the light guide. The term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

By definition, ‘broad-angle’ emitted light is defined as light having a cone angle that is greater than a cone angle of the view of a multiview image or multiview display. In particular, in some embodiments, the broad-angle emitted light may have a cone angle that is greater than about twenty degrees (e.g., >+20°). In other embodiments, the broad-angle emitted light cone angle may be greater than about thirty degrees (e.g., >±30°), or greater than about forty degrees (e.g., >±40°), or greater than about fifty degrees (e.g., >±50°). For example, the cone angle of the broad-angle emitted light may be greater than about sixty degrees (e.g., >±60°).

In some embodiments, the broad-angle emitted light cone angle may be defined to be about the same as a viewing angle of an LCD computer monitor, an LCD tablet, an LCD television, or a similar digital display device meant for broad-angle viewing (e.g., about ±40-65°). In other embodiments, broad-angle emitted light may also be characterized or described as diffuse light, substantially diffuse light, non-directional light (i.e., lacking any specific or defined directionality), or as light having a single or substantially uniform direction.

Embodiments consistent with the principles described herein may be implemented using a variety of devices and circuits including, but not limited to, one or more of integrated circuits (ICs), very large scale integrated (VLSI) circuits, application specific integrated circuits (ASIC), field programmable gate arrays (FPGAs), digital signal processors (DSPs), graphical processor unit (GPU), and the like, firmware, software (such as a program module or a set of instructions), and a combination of two or more of the above. For example, an image processor or other elements described below may all be implemented as circuit elements within an ASIC or a VLSI circuit. Implementations that employ an ASIC or a VLSI circuit are examples of hardware-based circuit implementations.

In another example, an embodiment of the image processor may be implemented as software using a computer programming language (e.g., C/C++) that is executed in an operating environment or a software-based modeling environment (e.g., MATLAB®, MathWorks, Inc., Natick, Mass.) that is executed by a computer (e.g., stored in memory and executed by a processor or a graphics processor of a computer). Note that one or more computer programs or software may constitute a computer-program mechanism, and the programming language may be compiled or interpreted, e.g., configurable or configured (which may be used interchangeably in this discussion), to be executed by a processor or a graphics processor of a computer.

In yet another example, a block, a module or an element of an apparatus, device or system (e.g., image processor, camera, etc.) described herein may be implemented using actual or physical circuitry (e.g., as an IC or an ASIC), while another block, module or element may be implemented in software or firmware. In particular, according to the definitions above, some embodiments described herein may be implemented using a substantially hardware-based circuit approach or device (e.g., ICs, VLSI, ASIC, FPGA, DSP, firmware, etc.), while other embodiments may also be implemented as software or firmware using a computer processor or a graphics processor to execute the software, or as a combination of software or firmware and hardware-based circuitry, for example.

Further, as used herein, the article ‘a’ is intended to have its ordinary meaning in the patent arts, namely ‘one or more’. For example, ‘a view’ means one or more views and as such, ‘the view’ means ‘views(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the term ‘substantially’ as used herein means a majority, or almost all, or all, or an amount within a range of about 51% to about 100%. Moreover, examples herein are intended to be illustrative only and are presented for discussion purposes and not by way of limitation.

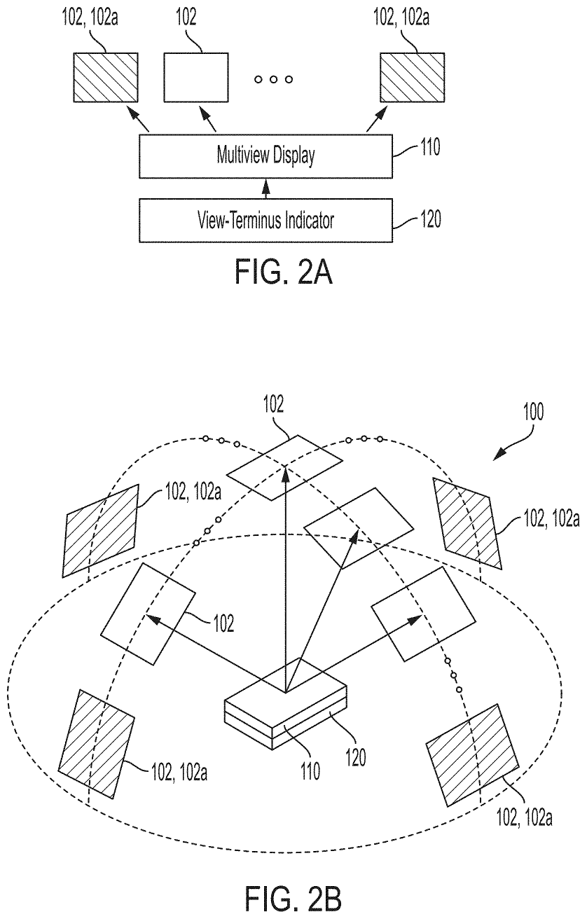

According to some embodiments of the principles described herein, a multiview display system is provided. FIG. 2A illustrates a block diagram of a multiview display system 100 in an example, according to an embodiment consistent with the principles described herein. FIG. 2B illustrates a perspective view of a multiview display system 100 in an example, according to an embodiment consistent with the principles described herein. The multiview display system 100 is configured to provide a multiview image comprising a plurality of views 102. The plurality of views 102 may be different perspective views of a scene represented by the multiview image. Further, the multiview display system 100 is configured to alert a user of an angular terminus of the view plurality of the multiview image.

As illustrated, the multiview display system 100 comprises a multiview display 110. According to various embodiments, the multiview display 110 may be substantially any of a variety of multiview displays configured to provide the multiview image. For example, the multiview display 110 may be substantially similar to the multiview display 10, previously described.

The multiview display 110 is configured to provide a plurality of views 102 representing a multiview image. Further, views 102 of the view plurality are arranged angularly adjacent to one another, according to various embodiments. For example, the plurality of views 102 may be angularly arranged adjacent to one another to form a linear array, e.g., the views 102 illustrated on one of the semi-circular dashed line in FIG. 2B may represent a linear array. In another example, the view plurality may form a two-dimensional (2D) array of angularly adjacent views 102. The 2D array may a rectilinear array or a circular array when considered in a planar projection of the angularly adjacent views 102, for example.

As describe below in more detail, the plurality of views 102 includes a terminal view 102a representing a view 102 at the angular terminus of the angularly adjacent views 102 of the view plurality, according to various embodiments. For example, when the view plurality is arranged as a linear array, the terminal view 102a may represent a view 102 at one or both ends of the linear array. Similarly, the terminal view(s) 102a may be along a periphery of views arranged as a 2D array, for example.

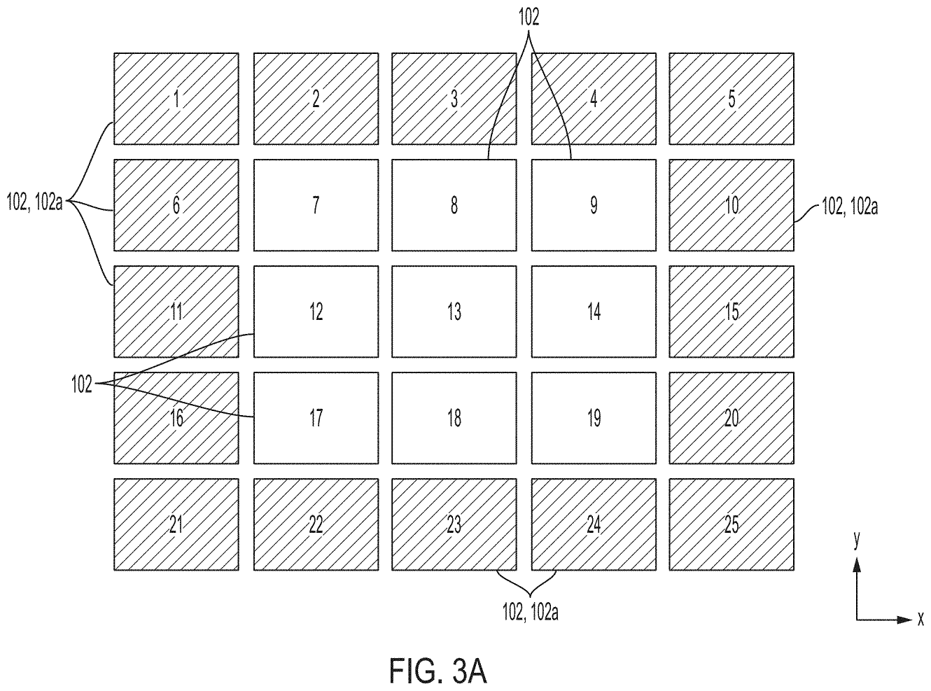

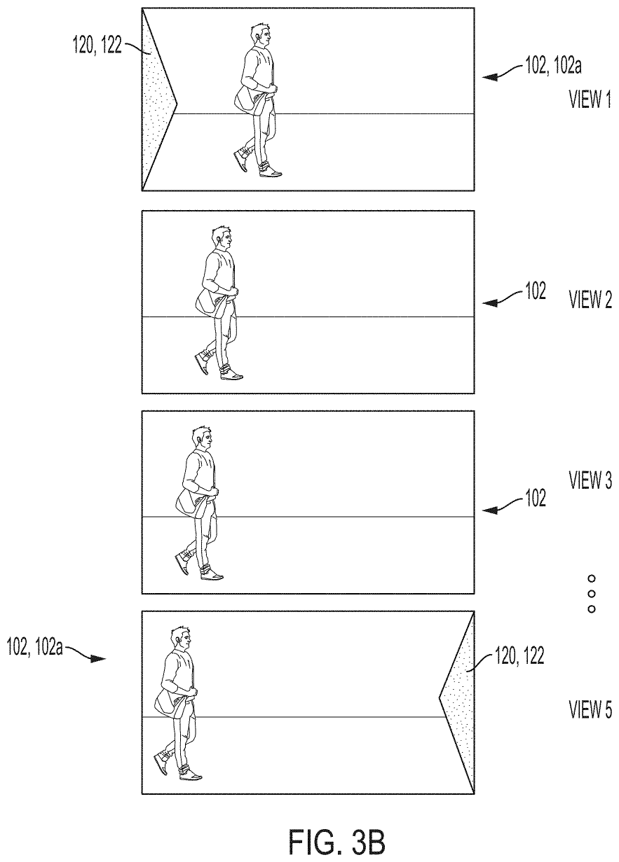

FIG. 3A illustrates a planar projection of a plurality of views 102 of the multiview display system 100 of FIG. 2A in an example, according to an embodiment consistent with the principles described herein. In particular, the view plurality illustrated in FIG. 3A corresponds the view plurality of the multiview display 110 arranged arranged as a 2D rectangular array that includes twenty-five (25) angularly adjacent views 102 as a five-by-five (5×5) array. Each view 102 of the view plurality may represent a different perspective of a scene that is displayed by the multiview display 110 as the multiview image. Further, each perspective may be complementary with the perspectives of the angularly adjacent views 102 of the multiview display 110. For example, views numbered 6, 7, and 8 represent consecutive and complementary perspectives of a scene in the multiview image along a row of the plurality of views 102. Similarly, views numbered 17, 12, 7, and 2 represent consecutive and complementary perspectives of a scene in the multiview image along a column of the plurality of views 102.

The plurality of views 102 is delimited by a set of terminal views 102a, each representing the last view or perspective of a scene along a certain direction of the multiview image. For example, as illustrated in FIG. 3A, the plurality of angularly adjacent views 102 in the direction of the single row comprising VIEW 7 is terminated at one end by VIEW 6 and at another end by VIEW 10. Accordingly, VIEW 6 represents a terminal view 102a of the plurality of views 102, as does VIEW 10 of the plurality of views 102. Similarly, VIEW 2 and VIEW 22 are terminal views 102a of the plurality of views 102 in the column comprising VIEW 7. Thus, the terminal views 102a of the plurality of views 102 comprise the peripheral views 102 of the view plurality, as illustrated.

FIG. 3B illustrates a planar projection of a plurality of views 102 of the multiview display system 100 of FIG. 2A in an example, according to another embodiment consistent with the principles described herein. In particular, FIG. 3B illustrates a sequence of angularly adjacent views 102 of the view plurality of the multiview display 110 arranged in a single row as a linear array. The linear array may represent either a horizontal linear array or a vertical linear array relative to a user, for example. FIG. 3B also illustrates terminal views 102a at opposite ends of the linear array and representing a first perspective (VIEW 1) and a last perspective (VIEW 5) of the scene of the multiview image.

The multiview display system 100 further comprises a view-terminus indicator 120. The view-terminus indicator 120 is associated with the terminal view(s) 102a of the plurality of views 102. According to various embodiments, the view-terminus indicator 120 is configured to alert a user of the multiview display system 100 to an angular terminus of the view plurality. That is, the view-terminus indicator 120 is configured to signal to the user that the current view being seen by the user represents or includes the terminal view 102a of the plurality of views 102. A user who is alerted by the view-terminus indicator 120 may thus understand that he or she has reached the last angular perspective of the scene, and may thus avoid moving the multiview display system 100 or his or her head in such a way as to bring about an additional view into sight.

According to various embodiments, the view-terminus indicator 120 may comprise any of a number of different indicators or similar signals to the user that the terminal view 102a has been reached. In particular, the view-terminus indicator 120 may comprise a visual indicator, in some embodiments. The visual indicator is configured to provide a visual indication of the terminal view 102a of the plurality of views 102, according to various embodiments.

In some embodiments, the view-terminus indicator 120 as the visual indicator may be located on the multiview display system 100, e.g., on a surface of the multiview display 110. For example, the visual indicator may comprise one or more LEDs located on or near the screen of the multiview display 110. The LED(s) may be configured to alert the user of the multiview display system 100 that he has reached an angular terminus of the view plurality.

In some embodiments, the view-terminus indicator 120 comprises a graphical overlay 122 on the terminal view 102a. The graphical overlay 122 is configured to alert the user of the angular terminus of the plurality of views 102. The graphical overlay 122 may be added to the terminal view 102a using a graphics processor unit (GPU) or similar processor of the multiview display system 100, for example. FIG. 3B illustrates a graphical overlay 122 of the view-terminus indicator 120 on each of the two terminal views 102a, namely VIEW 1 and VIEW 5. As illustrated, the graphic overlay is an arrow-shaped symbol that points the user away from the terminal view 102a and back toward other views (e.g., VIEW 2, VIEW 3, and VIEW 4) of the view plurality. Note, the arrow-shaped symbol illustrated a side of the terminal views 102a in FIG. 3B is provided for illustration purpose and not by way of limitation.

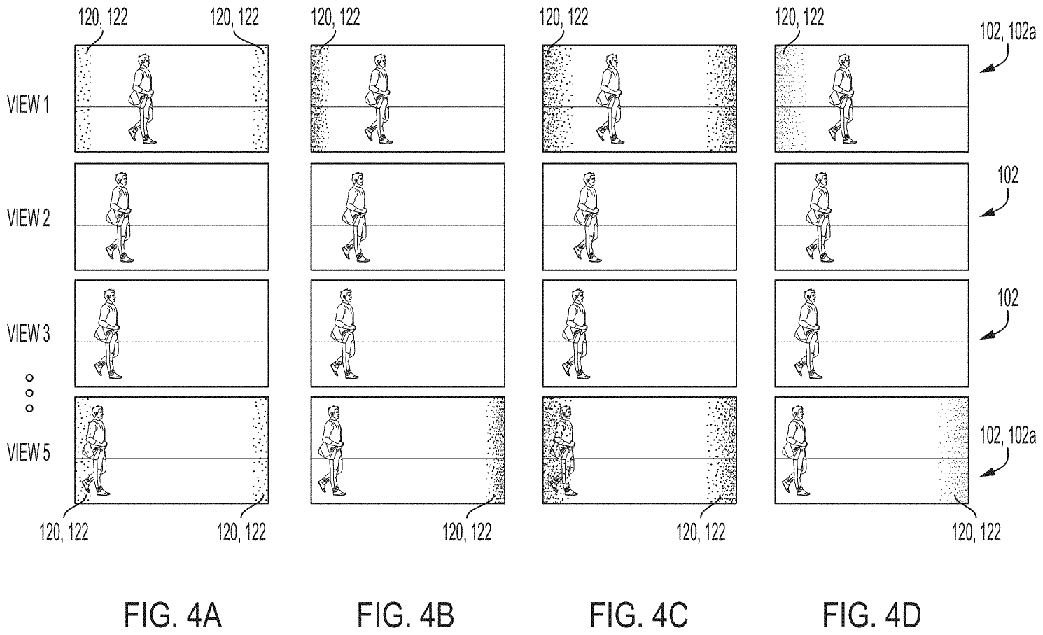

FIGS. 4A-4D illustrate various graphical overlays 122 in examples, according to embodiments consistent with the principles described herein. In particular, in FIG. 4A, the graphical overlay 122 on terminal views 102a (VIEW 1 and VIEW 5) comprises a pair of vertical columns disposed on both vertical edges of each of the terminal views 102a. The vertical columns alert the user of the multiview display system 100 that an angular terminus of the view plurality has been reached. The graphical column as the graphical overlay 122 on the terminal view 102a may have a color. In some embodiments, the graphical column may have a red color, or any other color configured to contrast against the scene displayed on the terminal view 102a to ensure that the view-terminus indicator 120 is visible to the user. Other configurations for the view-terminus indicator 120 are available. For example, the graphical overlay 122 may comprise a pair of faded columns at the vertical edges of the terminal views 102a, such as in FIG. 4C. In some embodiments, the graphical overlay 122 may comprise one or more overlays in the middle of the view, or any other portion of the view.

In some embodiments, as mentioned above, the graphical overlay 122 of the view-terminus indicator 120 as a visual indicator may be configured to direct a user away from an angular range beyond the angular terminus. That is, the user may be directed away from the terminal view 102a toward a non-terminal view 102 to prevent further relative motion from the user that may take the user beyond the terminal view 102a of the view plurality that makes up the multiview image. The view-terminus indicator 120 as a visual indicator configured to direct the viewer away from the terminal view 102a may comprise a variety of forms. For example, in the embodiment illustrated in FIG. 4B, the view-terminus indicator 120 comprises a single graphical overlay 122 (a column) adjacent the edge of the terminal view 102a that is in the direction of the angular terminus—or equivalently, the edge of the terminal view 102a that is opposite of the preceding view in a sequence of views 102 that lead to user to the terminal view 102a. The placement of the graphical overlay 122 of the view-terminus indicator 120 thus signals to the user that no further views 102 are available beyond the edge of the terminal view 102a where the graphical overlay 122 is located. The view-terminus indicator 120 of FIG. 4D operates on the same principle but comprises a faded column. As with the view-terminus indicator 120 of FIG. 4B, the placement of the view-terminus indicator 120 signals to the user that no further views 102 are available beyond the edge of the terminal view 102a where the view-terminus indicator 120 as a graphical overlay 122 is overlaid.

The view-terminus indicator 120 may direct the viewer away from the terminal view 102a using attributes beside its location within the terminal view 102a. For example, the view-terminus indicator 120 may direct the user away from the terminal view 102a using its shape. In some embodiments, an arrow may appear in the middle of the terminal view 102a (or any other location of the view) pointing the user away from the terminal view 102a and back to non-terminal views 102. In other embodiments, the view-terminus indicator 120 may comprise text overlaid on the terminal view 102a, the text alerting the user that he has reached a view-terminus and instructing the user to rotate the multiview display 110 or move their head in a direction that would bring non-terminal views 102 to their eyes. FIG. 3B also illustrates an example of a view-terminus indicator 120 comprising a visual indicator (i.e., a graphical overlay 122 comprising a arrow-shape symbol) configured to direct the user away from the terminal view 102a.

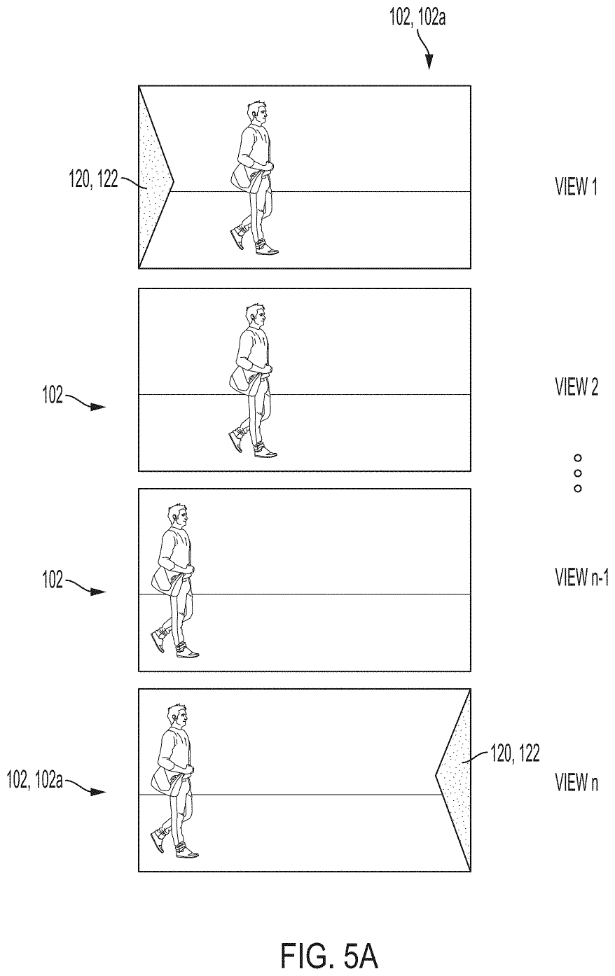

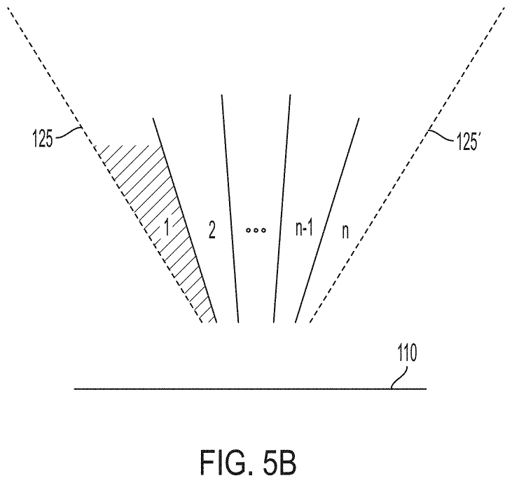

FIG. 5A illustrates another plurality of views 102 comprising terminal views 102a in an example, according to an embodiment consistent with the principles described herein. As illustrated, the plurality of views 102 comprises a pair of views (VIEW 1 and VIEW 2) adjacent to the angular terminus at the beginning of the plurality of views 102. The plurality of views 102 further comprises another pair of views (VIEW n−1 and VIEW n), adjacent to the angular terminus at the end of the plurality of views 102. The views 102 of each pair are duplicates of one another. That is, whereas adjacent views 102 of the plurality of views 102 typically represent adjacent and different perspectives of a scene in a multiview image, the images provided by the multiview display 110 on each of the pair of views, VIEW 1 and VIEW 2, are identical. Similarly, the images provided by the multiview display 110 on each of the pair of views, VIEW n−1 and VIEW n, are identical.

FIG. 5B illustrates a side view of an angular extent of the plurality of views of FIG. 5A in an example, according to an embodiment consistent with the principles described herein. VIEW 1 adjacent to the angular terminus 125 is a terminal view 102a. That is, VIEW 1 is the last view of the scene of the multiview image along the direction from VIEW n to VIEW 1. The angular extent of the VIEW 1 is depicted as a shaded area labeled ‘1’ in FIG. 5B. In this embodiment, the view-terminus indicator 120 is configured to alert the user of the angular terminus 125 only when the user is within the shaded area, which corresponds to the angular extent of VIEW 1. The duplication of the terminal views 102a (or VIEW 1) to the adjacent VIEW 2 (or vice versa) resulting in identical images in both VIEW 1 and VIEW 2 allows the user to view an image of VIEW 1 in VIEW 2 that is free from view-terminus indicators 120 before such indicators are triggered when the relative motion of the head of the user with respect to the multiview display 110 places it into the angular extent of VIEW 1. The same principle applies to the pair of views, VIEW n−1 and VIEW n, adjacent to the angular terminus 125′.

In some embodiments, the view-terminus indicator 120 may not comprise a visual indicator. In particular, the view-terminus indicator 120 may comprise a haptic indicator configured to provide haptic feedback to the user, according to these embodiments. The haptic feedback provided by the haptic indicator represents the alert of the angular terminus 125 of the plurality of views 102. Accordingly, the multiview display system 100 may provide this feedback to a user who reaches the terminal view 102a during the course of operating the multiview display system 100. In some embodiments, the haptic indicator of the view-terminus indicator 120 may be stand-alone in which haptic feedback provides the sole alert to the user. In other embodiments, the haptic feedback from a haptic indicator may be provided in concert with a visual indicator of the view-terminus indicator 120 to alert the user. In some of these embodiments, the haptic feedback may be synchronized with the visual indicator. For example, the visual indicator may be a flashing indicator and the haptic feedback may be synchronized with the flashes of the visual indicator.

In some embodiments (not illustrated), the multiview display system 100 may further comprise a viewing-angle tracker. The viewing-angle tracker is configured to determine a viewing angle of the user relative to the multiview display 110. The viewing-angle tracker may determine viewing angle in any of a variety of ways using any coordinate system compatible with the multiview display system 100. For example, the viewing angle may be determined by the viewing-angle tracker with respect to a vertical plane and/or a horizontal plane. The determined viewing angle of the user may be used to identify the position of the head of the user in space and specifically determine whether the user may be viewing a terminal view 102a. When the user's head is determined to be at a relative location corresponding to an angular extent of the terminal view 102a, the view-terminus indicator 120 may alert the user that a terminal view 102a has been reached. For example, user may be alerted one or both by using haptic feedback provided by the view-terminus indicator 120 comprising a haptic indicator and using a graphical overlay 122 provided by the view-terminus indicator 120 comprising a visual indicator.

In some embodiment, the viewing angle tracker may comprise a motion tracker. The motion tracker of the viewing angle tracker is configured to track a motion of the multiview display 110. The motion of the multiview display 110 may be tracked in three-dimensional space (i.e., along the x, y, and z axes). The motion tracker may comprise one or both of a hardware-based and software-based motion sensors. The hardware-based motion sensors may comprise a gyroscope, an accelerometer, a magnetometer, or a geomagnetic sensor, for example. Software-based sensors may comprise a gravity, linear acceleration, rotation vector, significant motion, step counter, or a step detector sensor. The hardware-based and software-based sensors are configured to track the motion of the multiview display 110.

The viewing-angle tracker may further comprise a user tracker. The user tracker is configured to track a location of the user relative to the multiview display 110. The location of the user may be tracked in three-dimensional space (i.e., along the x, y, and z axes). The user tracker may comprise optical sensors such as one or more of a camera, an infrared detector, or an iris detector, for example. The optical sensors are configured to track the location of the user relative to the multiview display 110.

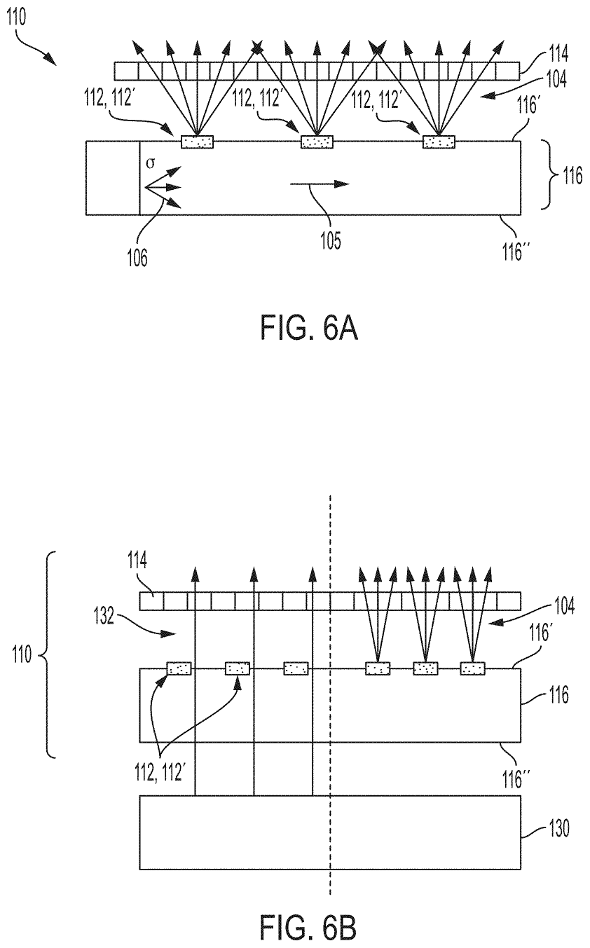

FIG. 6A illustrates a cross-sectional view of a multiview display 110 in an example, according to an embodiment consistent with the principles described herein. As illustrated in FIG. 6A, the multiview display 110 comprises an array of multibeam emitters 112. The multibeam emitters 112 of the multibeam emitter array are configured to provide directional light beams 104 directed away from the multiview display 110. According to various embodiments, the directional light beams 104 have principal angular directions corresponding to respective different view directions of the multiview display 110. In particular, FIG. 6A illustrates the directional light beams 104 as a plurality of diverging arrows depicted as directed away from a first (or top) surface of the multiview display 110 configured to support the multibeam emitter array, according to some embodiments.

According to various embodiments, the multibeam emitters 112 of the array may be located at or adjacent to the first surface of a multiview display 110, for example, as illustrated in FIG. 6A. In some embodiments, the plurality of multibeam emitters 112 may be located on a second surface of the multiview display 110. In some embodiments, the multibeam emitters 112 of the plurality may be located between the first surface and the second surface. The surfaces of the multiview display 110 may surfaces of a substrate configured to support the multibeam emitters 112 (e.g., a light guide 116, described further below), for example.

The multiview display 110 further comprises an array of light valves 114. In various embodiments, different types of light valves may be employed as the light valves 114 of the light valve array including, but not limited to, one or more of liquid crystal light valves, electrophoretic light valves, and light valves based on electrowetting. The array of light valves is configured to modulate the plurality of directional light beams to provide the different views representing the multiview image.

In some embodiments, the multiview display 110 further comprises a light guide 116, e.g., as the substrate. The light guide 116 is configured to guide light along a length of the light guide as guided light 106 (i.e., a guided light beam). For example, the light guide 116 may include a dielectric material configured as an optical waveguide. The dielectric material may have a first refractive index that is greater than a second refractive index of a medium surrounding the dielectric optical waveguide. The difference in refractive indices is configured to facilitate total internal reflection of the guided light 106 according to one or more guided modes of the light guide 116, for example.

In some embodiments, the light guide 116 may be a slab or plate of an optical waveguide (i.e., a plate light guide) comprising an extended, substantially planar sheet of optically transparent, dielectric material. The substantially planar sheet of dielectric material is configured to guide the guided light 106 using total internal reflection. According to various examples, the optically transparent material of the light guide 116 may include or be made up of any of a variety of dielectric materials including, but not limited to, one or more of various types of glass (e.g., silica glass, alkali-aluminosilicate glass, borosilicate glass, etc.) and substantially optically transparent plastics or polymers (e.g., poly(methyl methacrylate) or ‘acrylic glass’, polycarbonate, etc.). In some examples, the light guide 116 may further include a cladding layer (not illustrated) on at least a portion of a surface (e.g., one or both of the first surface and the second surface) of the light guide 116. The cladding layer may be used to further facilitate total internal reflection, according to some examples.

Further, according to some embodiments, the light guide 116 is configured to guide the guided light 106 according to total internal reflection at a non-zero propagation angle between a first surface 116′ (e.g., front or top surface or side) and a second surface 116″ (e.g., back or bottom surface or side) of the light guide 116. In particular, the guided light 106 propagates by reflecting or ‘bouncing’ between the first surface 116′ and the second surface 116″ of the light guide 116 at the non-zero propagation angle. In some embodiments, the guided light 106 may comprise a plurality of guided light beams having different colors of light and guided by the light guide 116 at respective ones of different color-specific, non-zero propagation angles. Note, the non-zero propagation angle is not illustrated in FIG. 5A for simplicity of illustration. However, a bold arrow depicting a propagation direction 105 illustrates a general propagation direction of the guided light 106 along the light guide length in FIG. 5A.

In some embodiments, the multibeam emitter 112 of the multiview display 110 comprises a multibeam element 112′. The multibeam element 112′ of the multiview display 110 is configured to scatter out light from the light guide 116 as a plurality of directional light beams having principal angular directions corresponding to view directions of a multiview image. According to various embodiments, the multibeam element 112′ may comprise any of a number of different structures configured to scatter out a portion of the guided light 106. For example, the different structures may include, but are not limited to, diffraction gratings, micro-reflective elements, micro-refractive elements, or various combinations thereof. In some embodiments, the multibeam element 112′ comprising a diffraction grating is configured to diffractively scatter out the guided light portion as the plurality of directional light beams having the different principal angular directions. In other embodiments, the multibeam element 112′ comprising a micro-reflective element is configured to reflectively scatter out the guided light portion as the plurality of directional light beams, or the multibeam element 112′ comprising a micro-refractive element is configured to scatter out the guided light portion as the plurality of directional light beams by or using refraction (i.e., refractively scatter out the guided light portion). Alternatively, in some embodiments, the multibeam emitter 112 comprises an active emitter such as, but not limited to, an light emitting diode (LED) that provides light as the directional light beams.

In some embodiments, a size of the multibeam emitter 112 or a size of the multibeam element 112′ is comparable to a size of a light valve 114 of the multiview display 110. Herein, the ‘size’ may be defined in any of a variety of manners to include, but not be limited to, a length, a width or an area. For example, the size of a light valve 114 may be a length thereof and the comparable size of the multibeam element 112′ may also be a length of the multibeam emitter 112 or multibeam element 112′. In another example, size may refer to an area such that an area of the multibeam emitter 112 or multibeam element 112′ may be comparable to an area of the light valve 114.

In some embodiments, the multiview display system 100 further comprises a broad-angle backlight 130 adjacent to the multiview display 110. FIG. 6B illustrates a cross-sectional view of a multiview display system 100 comprising a broad-angle backlight 130, according to an embodiment of the principles described herein. The broad-angle backlight 130 is opposite to a side of the light guide 116 adjacent to the light valve array. In the embodiment illustrated, the broad-angle backlight 130 is adjacent to a second (bottom) surface 116″ of the light guide 116. The broad-angle backlight 130 is configured to provide broad-angle light 132.

The light guide 116 and the array of multibeam elements 112′ may be configured to be optically transparent to broad-angle light 132 emitted from the adjacent broad-angle backlight 130. Thus, broad-angle light 132 may be emitted from the broad-angle backlight 130 and through a thickness of multiview display 110. The broad-angle light 132 from the broad-angle backlight 130 is therefore received through the second (bottom) surface 116″ of the multiview display 110, transmitted through a thickness of the multiview display 110, and emitted from the array of light valves 114. Because the multiview display 110 is optically transparent to the broad-angle light 132, the broad-angle light 132 is not substantially affected by the multiview display 110.

The multiview display system 100 of FIG. 6B may selectively operate in a two-dimensional (2D) mode or a multiview mode. In the 2D mode, the multiview display system 100 is configured to emit the broad-angle light 132 provided by the broad-angle backlight 130. In the multiview mode, the multiview display system 100 is configured to emit the directional light beams 104 provided by the multiview display 110 as previously described. The combination of multiview display 110 and broad-angle backlight 130 may be used in dual two-dimensional/three-dimensional (2D/3D) display, for example.

In some embodiments (not illustrated), the multiview display system 100 may further comprise a processing subsystem, a memory subsystem, a power subsystem, and a networking subsystem. The processing subsystem may include one or more devices configured to perform computational operations such as, but not limited to, a microprocessor, a graphics processor unit (GPU) or a digital signal processor (DSP). The memory subsystem may include one or more devices for storing one or both of data and instructions that may be used by the processing subsystem to provide and control operation the multiview display system 100. For example, stored data and instructions may include, but are not limited to, data and instructions configured to one or more of display the multiview image on the multiview display 110, implement the view-terminus indicator 120, and provide user tracking. For example, memory subsystem may include one or more types of memory including, but not limited to, random access memory (RAM), read-only memory (ROM), and various forms of flash memory.

In some embodiments, instructions stored in the memory subsystem and used by the processing subsystem include, but are not limited to program instructions or sets of instructions and an operating system, for example. The program instructions and operating system may be executed by processing subsystem during operation of the multiview display system 100, for example. Note that the one or more computer programs may constitute a computer-program mechanism, a computer-readable storage medium or software. Moreover, instructions in the various modules in memory subsystem may be implemented in one or more of a high-level procedural language, an object-oriented programming language, and in an assembly or machine language. Furthermore, the programming language may be compiled or interpreted, e.g., configurable or configured (which may be used interchangeably in this discussion), to be executed by processing subsystem, according to various embodiments.

In various embodiments, the power subsystem may include one or more energy storage components (such as a battery) configured to provide power to other components in the multiview display system 100. The networking subsystem may include one or more devices and subsystem or modules configured to couple to and communicate on one or both of a wired and a wireless network (i.e., to perform network operations). For example, networking subsystem may include any or all of a Bluetooth™ networking system, a cellular networking system (e.g., a 3G/4G/5G network such as UMTS, LTE, etc.), a universal serial bus (USB) networking system, a networking system based on the standards described in IEEE 802.12 (e.g., a WiFi networking system), an Ethernet networking system.

Note that, while some of the operations in the preceding embodiments may be implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the display technique may be implemented using program instructions, the operating system (such as a driver for display subsystem) or in hardware.

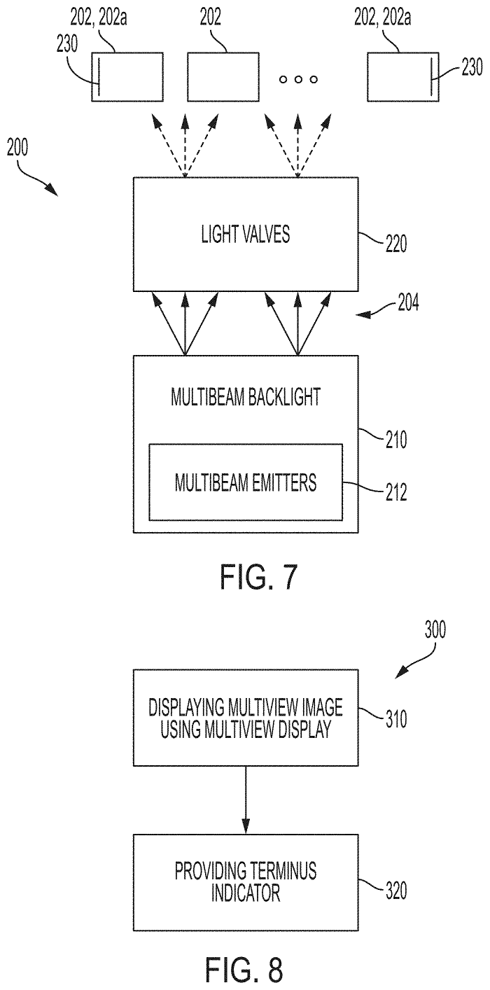

In accordance with some embodiments of the principles described herein, a multiview display is disclosed. FIG. 7 illustrates a block diagram of a multiview display 200 in an example, in accordance with an embodiment consistent with the principles described herein. The multiview display 200 comprises a multibeam backlight 210. The multibeam backlight 210 is configured to provide emitted light as a plurality of directional light beams 204 having principal angular directions corresponding to respective view directions of the multiview display 200 or equivalently view directions of a multiview image displayed by the multiview display 200. The multibeam backlight 210 may be shaped as a ‘slab’ or substantially flat block of substrate comprising two substantially parallel and opposite planar surfaces (i.e., a top and a bottom surface). Further, the multibeam backlight 210 comprises a plurality of multibeam emitters 212. The multibeam emitters 212 of the plurality may be located at or adjacent to a first surface of the multibeam backlight 210. In some embodiments, the plurality of multibeam emitters 212 may be located on a second surface of the multibeam backlight 210. In some embodiments, the multibeam emitters 212 of the plurality may be located inside the multibeam backlight 210 between the first surface and the second surface.

The multiview display 200 further comprises an array of light valves 220. The array of light valves 220 is substantially similar to the array of light valves 114 of the multiview display system 100, previously described. As such, different types of light valves may be employed as the light valves 220 of the light valve array including, but not limited to, one or more of liquid crystal light valves, electrophoretic light valves, and light valves based on electrowetting. The array of light valves 220 is configured to modulate the plurality of directional light beams 204 as a multiview image. The multiview image comprises a plurality of views 202 having directions corresponding to the different view directions. Each view of the plurality of views 202 may represent a different perspective of a scene, each perspective being complementary with the perspectives of the angularly adjacent views 202 provided by the multiview display 200.

The plurality of views 202 is delimited by a terminal view(s) 202a, each representing a last view 202 or perspective of a scene along a certain direction of the multiview image. Further, the multiview display 200 is configured to provide a view-terminus indicator 230 associated with a terminal view 202a of the multiview display 200. The view-terminus indicator 230 is configured to alert a user of the multiview display 200 to an angular terminus of the view plurality. That is, the view-terminus indicator 230 is configured to signal to the user that the current view being seen by the user represents a terminal view 202a of the plurality of views 202, which is also a terminal perspective of the scene of the multiview image.

According to some embodiments, the view-terminus indicator 230 may be substantially similar to the view-terminus indicator 120 of the multiview display system 100, described above. In particular, the view-terminus indicator 230 may comprise any of a variety of indicators or signals configured to alert the user that a terminal view 202a has been reached. For example, the view-terminus indicator 230 may comprise a visual indicator. In some embodiments, the visual indicator may be located on of the multiview display 200 (e.g., on a surface of the multiview display) and may comprise one or more light emitting diodes (LEDs), for example. In some embodiments, the visual indicator may comprise a graphic overly on or in the terminal view 202a. The graphic overlay may be substantially similar to the graphic overlay 122 of the multiview display system 100, previously described. For example, the graphic overlay on or in the terminal view 202a may comprise a pair of columns adjacent to the vertical edges of each of the terminal view(s) 202a. In some embodiments, the graphic overlay may be configured to direct the user away from the terminal view 202a. For example, the graphic overlay may comprise an arrow pointing in a direction away from the terminal view 202a and back towards other views 202 of the view plurality.

In some embodiments, the view-terminus indicator 230 may comprise a haptic indicator. The haptic indicator may be in addition to or instead of the visual indicator. The haptic indicator is configured to provide a haptic signal to indicate the terminal view 202a has been reached. For example, the haptic signal may be provided when the user arrives at the terminal view 202a. In another example, the haptic indicator may be provided when the user attempts to view a view beyond the terminal view 202a. The haptic indicator may also be used in concert with the visual indicator, for example providing vibrations that are synchronized with a flashing visual indicator.

In some embodiments (not illustrated), the multibeam backlight 210 comprises a light guide. The light guide is configured to guide light in a propagation direction along a length of the light guide as guided light. In some embodiments, the light guide may be substantially similar to the light guide 116 of the multiview display 110, previously described. According to various embodiments, the light guide may be configured to guide the guided light using total internal reflection. Further, the guided light may be guided at a non-zero propagation angle by or within the light guide. In some embodiments, the guided light may be collimated or may be a collimated light beam. In particular, the guided light may be collimated according to or having a collimation factor 6, in various embodiments.

In some embodiments, for example when the multibeam backlight 210 comprises a light guide, the plurality of multibeam emitters 212 may be or comprise a plurality of multibeam elements spaced apart from one another along the light guide length. In some embodiments, the multibeam elements of the multibeam element plurality are substantially similar to the multibeam elements of the above-described multiview display 110. The multibeam elements of the plurality are configured to scatter out a portion of the guided light as the directional light beams 204. According to various embodiments, directional light beams 204 of the directional light beam plurality have different principal angular directions corresponding to respective different view directions of the multiview display 200. The multibeam elements of the plurality may be located on surface of or within the light guide, in various embodiments.

In some embodiments, a size of the multibeam element of the multibeam element plurality or equivalently a size of a multibeam emitter 212 of the multibeam emitter plurality is comparable to a size of a light valve 114 of the light valve array. In some embodiments, the size is comparable to the light valve size such that the multibeam element size or equivalently the multibeam emitter size is between about fifty percent (50%) and about two hundred percent (200%) of the light valve size.

In some embodiments, the multibeam elements of the multibeam element plurality may comprise any of a number of different structures configured to scatter out a portion of the guided light. For example, the different structures may include, but are not limited to, diffraction gratings, micro-reflective elements, micro-refractive elements, or various combinations thereof. In some embodiments, the multibeam element comprising a diffraction grating is configured to diffractively scatter out the guided light portion as the plurality of directional light beams having the different principal angular directions. In other embodiments, the multibeam element comprising a micro-reflective element is configured to reflectively scatter out the guided light portion as the plurality of directional light beams, or the multibeam element comprising a micro-refractive element is configured to scatter out the guided light portion as the plurality of directional light beams by or using refraction (i.e., refractively scatter out the guided light portion).

The multiview display 200 may further comprise a light source optically coupled to an input of the light guide. The light source is configured to provide the light to the light guide. The light source may be located adjacent to an entrance surface of the light guide and may comprise substantially any source of light, including but not limited to, one or more LEDs or a laser. In some embodiments, the light source may comprise a plurality of different optical emitters configured to provide different colors of light. In some embodiments, the light provided by the light source may be collimated or equivalently may be a collimated light beam. Moreover, the light may be collimated according to a collimation factor, a in various embodiments.

In accordance with some embodiments of the principles described herein, a method of multiview display operation is provided. FIG. 8 illustrates a flowchart of a method 300 of multiview display operation in an example, according to an embodiment consistent with the principles described herein. The method 300 of multiview display operation comprises displaying 310 a multiview image using a multiview display, the multiview image comprising a plurality of views that are angular adjacent to one another. In particular, each view of the plurality of views may represent a different perspective of a scene displayed as the multiview image on the multiview display. Further, each perspective may be complementary with the perspectives of the angularly adjacent views of the view plurality. In some embodiments, the multiview display may be substantially similar to the multiview display 110 and the plurality of views may be substantially similar to the plurality of views 102 of the multiview display system 100, previously described.

The method 300 of multiview display operation illustrated in FIG. 8 further comprises providing 320 a view-terminus indicator associated with a terminal view of the view plurality, the terminal view representing the last view or perspective of a scene along a certain direction of the image. The view-terminus indicator is configured to alert a user of the multiview display system to an angular terminus of the view plurality. Thus, the view-terminus indication is configured to signal to the user that the current view being seen by the user represents or is adjacent to a terminal view of the plurality of views, which is also a terminal perspective of the scene of the multiview image. In some embodiments, the view-terminus indicator may be substantially similar to the view-terminus indicator 120 described above with respect to the multiview display system 100.

In some embodiments, the method 300 further comprises providing the view-terminus indicator comprising one or both of including a visual indicator within the terminal view of the plurality of views and generating haptic feedback to alert the user to the angular terminus of the view plurality. In some embodiments, the visual indicator may be located on a surface of the multiview display, and may comprise one or more LEDs, for example. In some embodiments, the visual indicator may comprise a graphic overly on the terminal view. Further, the haptic feedback may be provided in addition or instead of the visual indicator. Where the haptic feedback is provided in addition to the visual indicator, they may be synchronized.

In some embodiments, the method 300 further comprises directing the user away from the terminal view and toward other views of the view plurality using the view-terminus indicator. For example, the visual indicator may comprise one or more arrows pointing toward or one more of the other views. In some embodiments, the location of the visual indicator on the view may indicate the relative location of the other views.

In some embodiments, displaying 310 the multiview image comprises generating directional light beams using a multibeam backlight comprising a plurality of multibeam elements spatially distributed across the multibeam backlight. In some embodiments, the multibeam elements may be substantially similar to the multibeam elements 112′ of the multiview display 110, previously described. In particular, the directional light beams have different principal angular directions corresponding to view directions of respective different views of the plurality of views. Displaying 310 the multiview image further comprises modulating the directional light beams using an array of light valves to provide the plurality of views as the multiview image. In some embodiments, the array of light valves may be substantially similar to the array of light valves 114 of the multiview display 110, previously described. Further, a size of a multibeam element of the multibeam element plurality is comparable to a size of a light valve of the light valve array. For example, a size of the multibeam element may be between fifty percent and two hundred percent to a size of a light valve of the light valve array.

Thus, there have been described examples and embodiments of a multiview display system, multiview display, and method comprising a view-terminus indicator associated with a terminal view of a view plurality wherein the view-terminus indicator is configured to alert a user to the terminal view. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A multiview display system comprising:
a multiview display configured to provide a plurality of views representing a multiview image, views of the view plurality being arranged angularly adjacent to one another; and
a view-terminus indicator associated with a terminal view of the view plurality,
wherein the view-terminus indicator is configured to alert a user of the multiview display system to an angular terminus of the view plurality.

2. The multiview display system of claim 1, wherein the view-terminus indicator comprises a visual indicator configured to provide a visual indication of the terminal view of the view plurality.

3. The multiview display system of claim 2, wherein the visual indicator comprises a graphical overlay on the terminal view configured to alert the user of the angular terminus of the view plurality.

4. The multiview display system of claim 3, wherein the graphical overlay is further configured to direct a user away from an angular range beyond the angular terminus.

5. The multiview display system of claim 1, wherein the view-terminus indicator comprises a haptic indicator configured to provide haptic feedback to the user representing the alert of the angular terminus of the view plurality.

6. The multiview display system of claim 1, wherein the view plurality comprises a pair of views adjacent to the angular terminus, views of the view pair being duplicates of one another and the view-terminus indicator being exclusively associated with a first view of the view pair immediately adjacent to the angular terminus, wherein the view-terminus indicator is configured to alert the user of the angular terminus only when the user is at an angle relative to the multiview display corresponding to an angular extent of the first view.

7. The multiview display system of claim 1, further comprising a viewing-angle tracker configured to determine a viewing angle of the user relative to the multiview display, the view-terminus indicator being configured to alert the user at a determined viewing angle corresponding an angular extent of the terminal view, wherein the viewing-angle tracker comprises one or both of a motion tracker configured to track a motion of the multiview display and a user tracker configured to track a location of the user relative to the multiview display.

8. The multiview display system of claim 1, the multiview display comprising:
a plurality of multibeam emitters spatially distributed across the multiview display, each multibeam emitter of the multibeam emitter plurality being configured to provide a plurality of directional light beams having different principal angular directions corresponding to different view directions of different views of the view plurality; and
an array of light valves configured to modulate the plurality of directional light beams to provide the different views representing the multiview image.

9. The multiview display system of claim 8, the multiview display further comprising a light guide configured to guide light along a length of the light guide as guided light, the multibeam emitter comprising a multibeam element configured to scatter out a portion of the guided light as the plurality of directional light beams,
wherein a size of the multibeam element is comparable to a size of a light valve of the light valve array.

10. The multiview display system of claim 9, wherein the multibeam element comprises one or more of a diffraction grating configured to diffractively scatter out the portion of the guided light as the plurality of directional light beams, a micro-reflective structure configured to reflectively scatter out the portion of the guided light as the plurality of directional light beams, and a micro-refractive structure configured to refractively scatter out the portion of the guided light as the plurality of directional light beams.

11. The multiview display system of claim 8, further comprising a broad-angle backlight adjacent to a side of the multiview display opposite to a side adjacent to the light valve array, the broad-angle backlight being configured to provide broad-angle emitted light during a two-dimensional (2D) mode of the multiview display system, light valve array being configured to modulate the broad-angle emitted light as a 2D image,
wherein the multiview display is configured to be transparent to the broad-angle emitted light, the multiview display system being configured to display the multiview image during a multiview mode and the 2D image during the 2D mode.

12. A multiview display comprising:
a multibeam backlight configured to provide emitted light as a plurality of directional light beams having different principal angular directions corresponding to respective different view directions of the multiview display, the multibeam backlight comprising a plurality of multibeam emitters configured to emit the plurality of directional light beams having different principal angular directions corresponding to the respective different view directions of the multiview display; and
an array of light valves configured to modulate the plurality of directional light beams as a multiview image comprising a plurality of views having directions corresponding to the different view directions,
wherein the multiview display is configured to provide a view-terminus indicator associated with a terminal view of the view plurality.

13. The multiview display of claim 12, wherein the multibeam backlight comprises a light guide configured to guide light in a propagation direction along a length of the light guide as guided light, and wherein the plurality of multibeam emitters is a plurality of multibeam elements spaced apart from one another along the light guide length, a multibeam element of the plurality of multibeam elements being configured to scatter out from the light guide a portion of the guided light as the directional light beams,
a size of the multibeam element being between fifty percent and two hundred percent to a size of a light valve of the light valve array.

14. The multiview display of claim 13, wherein the multibeam element comprises one or more of a diffraction grating multibeam element, a micro-reflective multibeam element, and a micro-refractive multibeam element.

15. The multiview display of claim 13, further comprising a light source optically coupled to an input of the light guide of the multibeam backlight, the light source being configured to provide light to be guided in the light guide as the guided light one or both of having a non-zero propagation angle and being collimated according to a predetermined collimation factor.

16. The multiview display of claim 12, wherein the view-terminus indicator comprises one or both of a visual indicator and a haptic indicator, the visual indicator being configured to provide a visual indication within the terminal view of the view plurality of the multiview image and the haptic indicator being configured to provide a haptic signal to indicate the terminal view.

17. A method of multiview display system operation, the method comprising:
displaying a multiview image using a multiview display, the multiview image comprising a plurality of views that are angularly adjacent to one another; and
providing a view-terminus indicator associated with a terminal view of the view plurality, the view-terminus indicator alerting a user of the multiview display system to an angular terminus of the view plurality.

18. The method of multiview display system operation of claim 17, wherein providing the view-terminus indicator comprises one or both of including a visual indicator within the terminal view of the plurality of views and generating haptic feedback to alert the user to the angular terminus of the view plurality.

19. The method of multiview display system operation of claim 17, further comprising directing the user away from the terminal view and toward other views of the view plurality using the view-terminus indicator.

20. The method of multiview display system operation of claim 17, wherein displaying a multiview image comprises:
generating directional light beams using a multibeam backlight comprising a plurality of multibeam elements spatially distributed across the multibeam backlight, the directional light beams having different principal angular directions corresponding to view directions of respective different views of the plurality of views; and
modulating the directional light beams using an array of light valves to provide the plurality of views as the multiview image,
wherein a size of a multibeam element of the multibeam element plurality is comparable to a size of a light valve of the light valve array.
